(19) United States
(12) Patent Application Publication
(10) Pub. No.: US 2018/0232811 A1
(43) Pub. Date: Aug. 16, 2018

(54) RENEWABLE ENERGY TRUST SYSTEM AND METHOD

(71) Applicant: Inventus Holdings, LLC, Juno Beach, FL (US)

(72) Inventor: Mark Palanchian, Juno Beach, FL (US)

(21) Appl. No.: 15/433,071

(22) Filed: Feb. 15, 2017

(51) Int. Cl. G06Q 40/06; G06Q 50/06

(52) U.S. Cl. CPC G06Q 40/06; G06Q 50/06

(57) ABSTRACT

A renewable energy trust management system, method and computer program product, for funding a renewable energy trust for construction of renewable energy sources coupled to a power grid is disclosed. The system includes a trust management computer and at least one trust management module stored in memory and executable by a processor to facilitate the deposit of funds received from users of energy by directing data over a communications network operably coupled to the trust management computer. The data represents payments to the trust from at least one of renewable energy credits (RECs), REC-related product sales, direct contributions, and donations. The RECs are provided to consumers of energy connected to the grid, from a power generation system in proportion to the amount of energy respectively consumed from the power generation system. The RECs enable the construction of a portion of a renewable energy source in response to determining, by the trust management computer, a funding level of the renewable energy trust, a portion of which is funded by the RECs, where the renewable energy source is connected to the grid to provide clean energy to consumers of energy.

### FIELD OF THE DISCLOSURE

The present disclosure relates to a renewable energy trust system and method for funding a renewable energy trust that applies funds in the trust or a portion thereof to renewable energy initiatives. Specifically, the system bundles energy credits provided to customers in connection with the purchase of energy supplied over a power grid in accordance with ISO power generation standards, and these credits are utilized to fund a portion of the trust to ultimately fund clean energy power generation.

### BACKGROUND

Consumers of energy and the world community have long been seeking alternatives to conventional power generation to reduce the environmental impact of fossil fuels such as coal, oil and natural gas. Such alternatives include reducing overall consumption, increasing energy efficiency and exploiting natural resources.

According to the U.S. Department of Energy, Americans annually emit over seven billion metric tons of greenhouse gases into the atmosphere. These include but are not limited to carbon dioxide, methane, nitrous oxide, chlorofluorocarbons, hydrochlorofluorocarbons, ozone, hydrofluorocarbons, perfluorocarbons and sulfur hexafluoride. The vast majority of the electricity consumed by the public is generated by power plants using fossil fuels.

Combustion of fossil fuels is largely responsible for greenhouse gas emissions, and these have been linked to the issue of climate change. Excessive fossil fuel use has been associated with an increase in severe weather events, including higher worldwide temperatures, melting icecaps, flooding and drought. Left unchecked, it is possible that climate change will adversely impact our natural ecosystems, and ultimately cause species extinction.

There is an increasing focus in the industry on using renewable energy to replace fossil fuels with cleaner, more environmentally friendly energy generation methods. In this connection, renewable energy is energy generated using natural resources, i.e., sunlight, wind, rain, biomass, tides, wave, hydroelectric and geothermal heat and waste—all of which are naturally replenished. Because this type of energy utilizes natural resources, it is often referred to as “green energy.” With respect to electricity, various states now require by regulation that local utilities permit green energy providers to access the power grid. Unfortunately, green power still constitutes less than 2% of the total electricity generated in the U.S.

### SUMMARY OF THE DISCLOSURE

In accordance with an aspect of the present disclosure, there is provided a renewable energy trust management system, method and computer program product, for funding a renewable energy trust for construction of renewable energy sources coupled to a power grid is disclosed. The system includes a trust management computer and at least one trust management module stored in memory and executable by a processor to facilitate the deposit of funds received from users of energy by directing data over a communications network operably coupled to the trust management computer. The data represents payments to the trust from at least one of renewable energy credits (RECs), REC-related product sales, direct contributions, and donations. The RECs are provided to consumers of energy connected to the grid, from a power generation system in proportion to the amount of energy respectively consumed from the power generation system. The RECs enable the construction of a portion of a renewable energy source in response to determining, by the trust management computer, a funding level of the renewable energy trust, a portion of which is funded by the RECs, where the renewable energy source is connected to the grid to provide clean energy to consumers of energy.

In accordance with a further aspect of the disclosure, there is provided a computer program product composed of computer usable instructions stored in a non-transitory memory medium for a renewable energy trust management system. The computer usable instructions embody at least one trust management module, executable by a processor of a trust management computer, to facilitate the deposit of funds received from users of energy by directing data over a communications network representing payments to the trust from at least one of renewable energy credits (RECs), REC-related product sales, direct contributions, and donations. The RECs are provided to consumers of energy connected to the grid, from a power generation system in proportion to the amount of energy respectively consumed from the power generation system. The trust management module determines a funding level of the renewable energy trust and based upon such determination, enables the construction of a portion of a renewable energy source in response to the determined funding level of the renewable energy trust, a portion of which is funded by the RECs, where the renewable energy source is coupled to the grid to provide clean energy to consumers of energy.

These, as well as further objects and advantages of the present disclosure, will become readily apparent to those skilled in the art with reference to the following detailed description of the preferred embodiments and the several views of the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 is a high level schematic of a renewable energy trust system and method in accordance with aspects of the present disclosure;

FIG. 2 is a trust fund flow diagram according to a further aspect of the disclosure; and

FIG. 3 is flow diagram of the funding of and distribution from a renewable energy trust according to one embodiment of the disclosure.

### DETAILED DESCRIPTION OF THE PREFERRED EMBODIMENTS

As will be appreciated by those skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

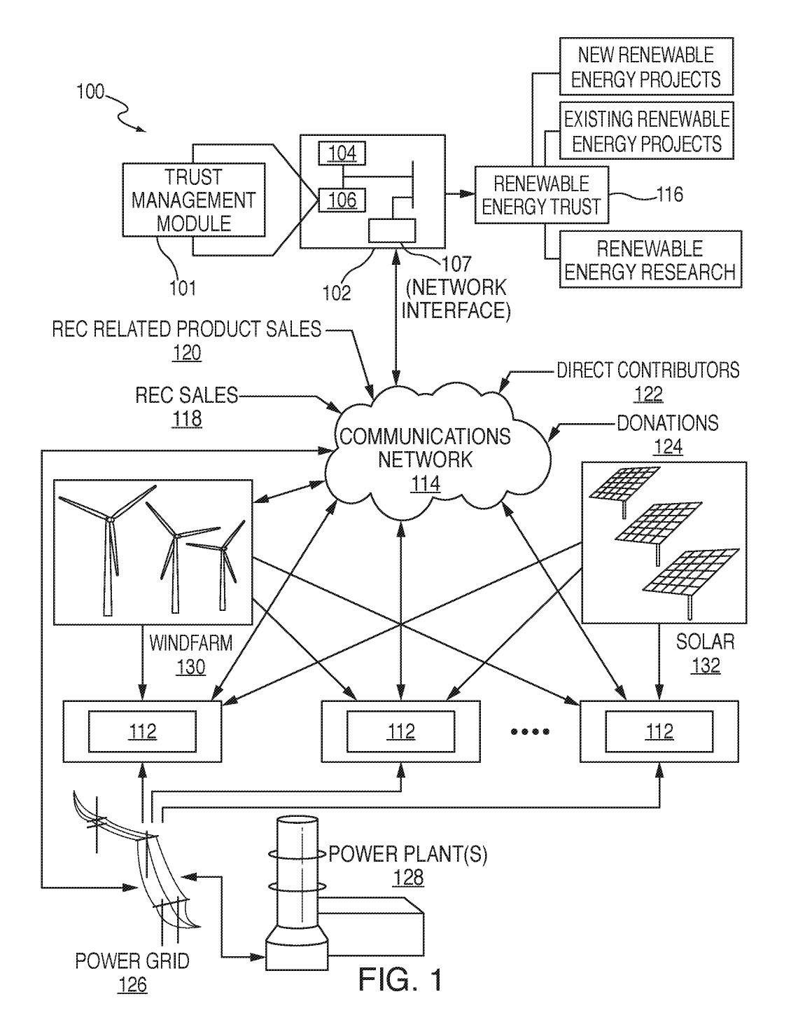

With reference to FIG. 1, there is pictorially depicted a renewable energy trust management system generally characterized by the reference numeral 100. The renewable energy trust management system 100 includes at least one trust management computer 102 including a processor 104 operably coupled to memory 106 and at least one trust management module 108 stored in the memory 106 and executable by the processor 104 to facilitate the deposit of funds 110 received from users 112 of energy by directing data over a communications network generally denoted by 114 operably coupled to the trust management computer 102 via a conventional network interface 107, and representing payments to the trust 116 from at least one of renewable energy credits (RECs) 118, REC-related product sales 120, direct contributions 122, and donations 124. The RECs 118 are provided to consumers of energy connected to a power grid 126 which connects a power generation system 128 to consumers 130 via ISO transmission. In accordance with an aspect of the disclosure, the RECs 118 are provided in proportion to the amount of energy respectively consumed and purchased by the consumers from the entity managing the power generation system 128. The RECs 118 are represented by data and communicated over the communications network between the energy provider, the consumers and the trust 116. The RECs 118 enable the construction of a portion of a renewable energy source, i.e., a wind farm 130 or solar power array/system 132, in response to determining, by the trust management computer 102, a funding level of the renewable energy trust 116, a portion of which is funded by the RECs, where the renewable energy source is connected to the grid to provide clean energy to consumers of energy.

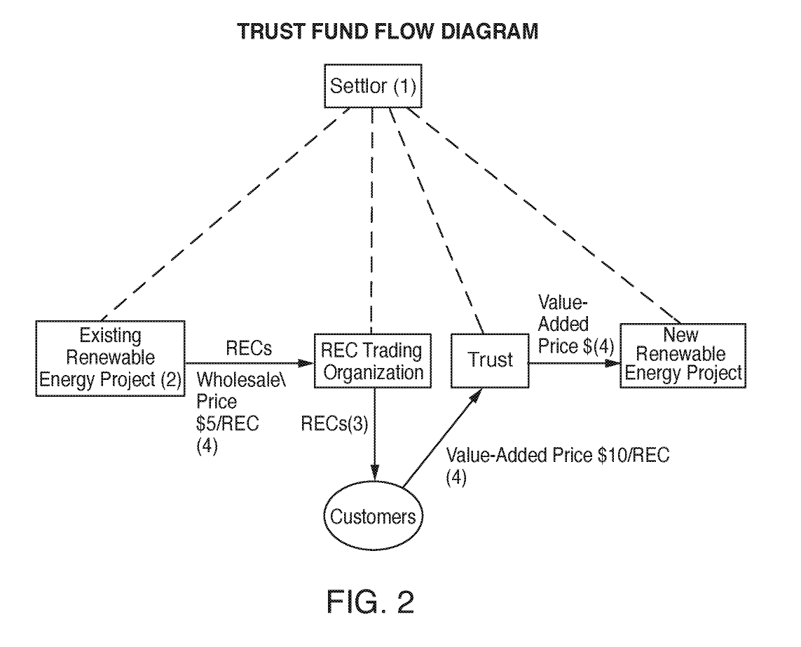

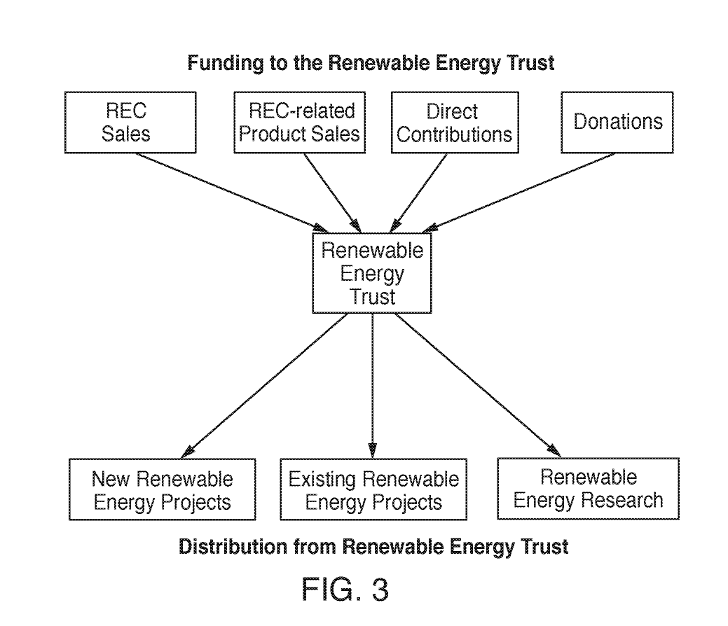

In view of the above and with reference to FIGS. 2 and 3, the present disclosure provides a renewable energy trust and methodology of using a renewable energy trust to develop renewable energy, comprising (1) establishing the renewable energy trust; (2) funding the renewable energy trust; and (3) using the funds in the renewable energy trust to develop renewable energy. In certain preferred embodiments, the renewable energy trust is irrevocable. In other embodiments, the renewable energy trust is at least partially funded by the sale of renewable energy credits. In other embodiments, 100% of the funds in the renewable energy trust are used to develop renewable energy. In other embodiments, the renewable energy is selected from hydroelectric, wind, solar, biomass, geothermal, tidal and wave energy, and waste energy. In other embodiments, at least a portion of the funds in the renewable energy trust are used to fund renewable energy projects or facilities.

In another embodiment, the present disclosure provides a method of funding a renewable energy trust, comprising (1) establishing a renewable energy trust; (2) transferring funds from an energy consumer; and (3) contributing the funds to the renewable energy trust. In certain embodiments, the funds in the renewable energy trust are generated through the sale of renewable energy credits. In other embodiments, the funds are transferred through the use of a computer, server or other machine. In other embodiments, the funds are contributed to the renewable energy trust through the use of a computer, server or other machine. In other embodiments, a computer hosts a web page on the internet through which the funds are transferred. In other embodiments, a computer accesses a web page on the internet through which the funds are transferred. In other embodiments, an internet web page contains a means for calculating the amount of funds to be transferred. In other embodiments, the means for calculating the amount of funds to be transferred is a calculator. In other embodiments, the calculator estimates a carbon footprint. In other embodiments, the carbon footprint is calculated using carbon dioxide generation from various metrics, including home, vehicle and travel. In other embodiments, the calculator estimates the amount of funds that should be transferred to offset a carbon footprint.

In accordance with another aspect of the disclosure, there is provided a method for funding the development of renewable energy which uses 100% of funds from a renewable energy trust to develop new renewable energy projects. In certain embodiments, the new projects are selected from wind, solar, geothermal, tidal, wave, hydroelectric, biomass and waste energy. In other embodiments, the contribution to the renewable trust is made directly or indirectly through the internet.

As used herein, “ANRGC” is intended to be an abbreviation for allowed new renewable generation costs.

As used herein, the term “biomass energy” is intended to mean energy derived from living and dead biological material that can be used as fuel or for industrial production. Typically, biomass refers to plant matter grown to generate electricity or produce biofuel. Biomass may also include biodegradable wastes that can be burnt as fuel.

As used herein, the term “carbon dioxide” is intended to mean the chemical compound having the formula CO₂ and being composed of two oxygen atoms covalently bonded to a single carbon atom. In addition to being a naturally occurring gas, carbon dioxide is also a by-product of the burning of fossil fuels and biomass, as well as land-use changes and other industrial processes. It is typically regarded as the principal anthropogenic greenhouse gas that affects the Earth's radiative balance and is the reference gas against which other greenhouse gases are measured and therefore has a Global Warming Potential (GWP) of 1.

As used herein, the term “carbon footprint” is intended to mean a measure of the impact human activities have on the environment in terms of the amount of green house gases produced, measured in units of carbon dioxide.

As used herein, the term “carbon neutral” is intended to mean a product or process that, over its lifecycle, does not contribute to the addition of carbon dioxide into the atmosphere. The term may be applied to individuals, businesses, or organizations whose practices contribute a net of zero carbon dioxide emissions to the atmosphere. This can be achieved by reducing or avoiding carbon-emitting activities such as driving and electricity use and by mitigating one's emissions through the use of carbon offsets.

As used herein, the term “carbon offset(s)” is intended to mean market-based instruments created by the development or management of offset projects whose purpose are to reduce, avoid or capture greenhouse gases. Such projects include production of renewable energy, afforestation, capture and destruction of methane and other greenhouse gases and energy-efficiency projects.

As used herein, the term “climate change” is intended to mean any significant change in measures of climate (temperature, precipitation or wind) lasting for an extended period (decades or longer). Climate change may result from natural factors, such as changes in the sun's intensity, slow changes in the Earth's orbit around the sun or other natural processes within the climate system such as changes in ocean circulation). Climate change is primarily discussed herein in connection with human activities that change the atmosphere's composition (e.g., through burning fossil fuels) and the land surface of the earth (e.g., deforestation, reforestation, urbanization, desertification, etc.).

As used herein, “computer” is intended to have its art-recognized meaning and includes any electronic machine capable of carrying out a designated task. Computers include without limitation servers, terminals, desktops, notebooks, laptops, tablet PCs, PDA's and other hand held electronic devices, cellular phones, and other similar devices.

As used herein, the term “conventional fuel” is intended to mean fossil fuels including coal, oil, and natural gas.

As used herein, the term “conventional power” is intended to mean power generation from sources such as oil, natural gas, or coal.

As used herein, the term “emissions” is intended to mean a substance discharged into the air, typically as a result of the use of fossil fuel.

As used herein, the term “fossil fuel” is intended to mean buried combustible geologic deposits of organic materials, formed from decayed plants and animals that have been converted to crude oil, coal, natural gas, heavy oils or sand tar by exposure to heat and pressure in the earth's crust over hundreds of millions of years.

As used herein, the term “geothermal energy” is intended to mean energy produced by the internal heat of the earth which includes: hydrothermal convective systems; pressurized water reservoirs; hot dry rocks; manual gradients; and magma. Geothermal energy can be used directly for heating or to produce electric power.

As used herein, the term “global warming” is intended to mean the progressive gradual rise of the earth's surface temperature thought to be caused by the greenhouse effect and responsible for changes in global climate patterns. Global warming has occurred in the distant past as the result of natural influences, but the term is most often used to refer to the warming predicted to occur as a result of increased emissions of greenhouse gases.

As used herein, the term “green energy” or “green power” is intended to mean energy, including electricity, produced from clean, renewable energy resources.

As used herein, the term “greenhouse effect” is intended to mean the effect produced as greenhouse gases allow incoming solar radiation to pass through the Earth's atmosphere, but prevent part of the outgoing infrared radiation from the Earth's surface and lower atmosphere from escaping into outer space.

As used herein, the term “greenhouse gases” is intended to mean any gas that absorbs infrared radiation in the atmosphere, including without limitation, water vapor, carbon dioxide, methane (CH₄), nitrous oxide (N₂O), chlorofluorocarbons (CFCs), hydrochlorofluorocarbons (HCFCs), ozone (O₃), hydrofluorocarbons (HFCs), perfluorocarbons (PFCs) and sulfur hexafluoride (SF₆).

As used herein, the term “grid” is intended to mean an electricity transmission and distribution system.

As used herein, the term “hydroelectric energy” is intended to mean electric energy made by the conversion of energy produced from running water.

As used herein, the term “renewable energy” is intended to mean electricity produced from hydroelectric, wind, solar, biomass, geothermal, tidal and wave energy, and waste-to-energy.

As used herein, the term “renewable energy credits” or “RECs” is intended to mean the sale of renewable energy, or the environmental benefits of renewable energy, made to consumers. RECs are also referred to as Green Tags or Renewable Energy Certificates. A REC represents 1,000 kWh (or 1 megawatt-hour) of electricity produced from a renewable energy source. Depending on the location and type of the facility that produces renewable energy and RECs, a REC may also represent the avoidance of the emission of 1,000 to 2,000 pounds of carbon dioxide.

As used herein, the term “REC-related products” is intended to mean any product related to a renewable energy credit (“REC”).

As used herein, the term “renewable energy trust” is intended to mean a trust created by a settlor, having a trustee, and formed with the intention of using the corpus (trust property) for the development of renewable energy technology, projects or facilities.

As used herein, the term “settlor” is intended to mean the entity that creates a trust. The term “settlor” includes without limitation affiliates of the settlor.

As used herein, the term “tidal energy” is a form of hydropower that converts the energy of tides into electricity or other useful forms of power.

As used herein, the term “solar energy” is intended to mean energy derived from the sun in the form of solar radiation. Electricity from the sun can be produced in two ways: photovoltaic electricity and solar thermal electricity.

As used herein, the term “wave energy” is intended to mean the transport of energy by ocean surface waves, and the capture of that energy to do useful work, for example, for electricity generation, desalination, or the pumping of water (into reservoirs).

As used herein, the term “wind energy” is intended to mean energy available from the movement of the wind across a landscape. The Sun's energy creates wind by heating the earth, oceans and atmosphere.

As noted, the present disclosure contemplates a renewable energy trust in which the trust property is held subject to certain obligations to use it for the development of renewable energy.

Generally speaking, the trust property may be distributed in any manner that serves the purpose for which the trust was created. The development of renewable energy includes any endeavor that is directed, in whole or in part, to generating energy from other than conventional sources. Thus, development of renewable energy includes without limitation the research and discovery of new green energy sources, improvements to known sources and hybrid solutions. The development of renewable energy also includes the implementation of renewable energy technology, projects and construction of energy facilities, such as electrical power plants.

It will be appreciated that the renewable energy trust may also be funded in any manner without deviating from the spirit of the disclosure. For example, the trust may be funded by direct contributions. In certain embodiments, direct contributions are made through the use of a computer. In other embodiments, described in greater detail below, the amount contributed to the trust property bears some logical relationship to the use or anticipated use of conventional power. In this regard, the contribution to the trust may be intended to serve as a specific or general carbon offset. In other embodiments, contributions to the trust are the result of purchases of renewable energy credits (RECs).

It is axiomatic that since most of conventional energy comes from the burning of fossil fuels that emit carbon into the atmosphere, the more energy being consumed, the larger the human impact on the environment. This carbon footprint represents a measure of the impact of human activities on the environment in terms of the amount of green house gases produced, measured in units of carbon dioxide. The use of this expression can be useful to conceptualize personal, business or organizational contribution to global warming and therefore may be useful in evaluating the amount of funds to be contributed to the renewable energy trust.

In order to minimize or eliminate a carbon footprint, individuals, business or other entities may strive to be carbon neutral. Generally speaking, carbon neutral represents a product, process or practice that, over its lifecycle, does not contribute to the addition of carbon dioxide into the atmosphere or contributes a net zero carbon dioxide emission. Carbon neutral can be approached or achieved by reducing, avoiding or eliminating carbon-emitting activities such as driving, electricity use, etc., or by mitigating emissions through the use of carbon offsets.

For example, the use of every day appliances consumes energy. An appliance may use 20 watts of power for approximately 10,000 hours over its lifetime, consuming approximately 200,000 watt-hours of energy. In addition, a manufacturing facility that produces the appliance will consume power to make, test, and package the appliance. Fossil fuels are also consumed transporting the appliance to the end consumer.

Given the amount of energy that a product or process uses, the carbon (e.g., CO₂) footprint of that product or process may be calculated. According to the U.S. Department of Energy, using 1,000 KWh is the equivalent of approximately 1,400 pounds of carbon dioxide. Therefore, the carbon footprint of appliance referred to above over its lifetime is approximately 280,000 pounds of carbon dioxide. Similar calculations can be made based on a vehicle's consumption of gasoline. In this way, a carbon footprint may be estimated for virtually any activity using simple equations, charts, demographic energy cost and consumption data.

It will be appreciated that calculating a carbon footprint is not an exact science and a variety of factors, such as the type of item, the location where the power is being consumed, and other factors may be relevant. Accordingly, a variety of sources may be used to estimate a given carbon footprint. Generally accepted sources, such as current U.S. data from the U.S. Census and the U.S. Energy Information Administration, provide information that may be used to calculate the carbon footprint of consumers or businesses.

Similarly, the U.S. Department of Transportation heads the Federal Highway Administration, which collects and validates useful data on vehicle registrations, licenses, fuel, miles traveled, and fuel use. Based on data analyzed from such sources, the average consumer of energy lives in a single home with a garage, drives a large car approximately 12,900 miles a year and travels via air travel an average of 17.2 hours per year. The average household has 1.8 vehicles. From this collective data, it can be calculated that the average American has a footprint of emitting 18.8 tons of carbon dioxide per year with one vehicle and 23.3 tons of carbon dioxide with a second vehicle. The data can be further used to calculate the typical consumption for a narrower base, including calculations by state, by county, or by zip code. This information may be organized into a computer database and used as a base from which a particular individual or entity's carbon footprint can be estimated.

Calculators may be used to estimate the carbon footprint of a particular individual, business or consumer product. Generally speaking, calculators may use any metric to estimate a carbon footprint, but typically, calculators combine information about energy consumption based on practices or behavior of a particular product, individual or entity. As such, carbon footprint calculators may consider virtually any energy factor, including type of residence, office, product, vehicle and travel patterns to name a few. In certain embodiments, the calculator may provide information regarding the carbon footprint simultaneously upon the entry of information about energy consumption.

To calculate estimated home energy emissions, a calculator may add the amount of emissions that come from the home's heating and cooling systems, as well as its power consumption and other characteristics. The age of the home, number of rooms, square footage, and number of people living in the household may also be used. Other components that may contribute to the final result may include energy conserving upgrades, conservation appliances, and luxury appliances or electronics. Calculators may also incorporate information from the U.S. Environmental Protection Agency's official website for Energy Star products, which provides information on qualified products and energy savings for home improvements.

By way of further illustration, in the case of a home, the type of home (e.g., single or multi family residence, town house or condo), a zip code or other information may be entered into the calculator. Additional homes may also be listed. In certain embodiments, the carbon footprint calculator may multiply the zip code's annual average consumption of kilowatt hours (kWh) per household by a percentage that is based on what home type is selected. The zip code may be entered and multiplied by a factor to result in average carbon dioxide emissions for that area. This may include the elements of home construction such as average insulation, windows rating, local climate conditions, etc. The carbon footprint may then be calculated by measuring the number of pounds of carbon dioxide emitted from each kilowatt hour of electricity generated.

A carbon footprint calculator may be implemented with homes categorized in any fashion or estimations may be made based on the global “typical” home. Carbon footprint calculators need not incorporate geographic designations, or may use other designations, such as by state, or by county, in its calculations. Carbon footprint calculators with more specific information may also be useful, taking in specific information such as the exact address, actual power consumption figures, or specific information about the heating and cooling systems, appliances and electronics in the home.

With similar reasoning, a carbon footprint calculator can use the equivalent power consumption demographic information for commercial space to calculate a corporation or other business entity's carbon footprint for its office(s), factory, buildings, etc.

A carbon footprint calculator may also take into account characteristics from a vehicle (or multiple vehicles), such as size, gas mileage, average miles per year, etc. Vehicles may be categorized based on the size, such as hybrid, small car, medium car, large car, SUV or truck, or in any other fashion. Calculations may be made based, for example, on the national averages for the type of car(s) selected or for averages based on more specific geographic regions. The calculator may use the total number of miles driven per year and the estimated fuel efficiency (mpg) of the vehicle type to calculate total emissions for driving in a given year. The carbon footprint calculator may also take into account local area fuel type, driving conditions, traffic patterns, etc. Alternatively, specific information about the vehicle, its fuel consumption and emissions may be used in the calculation.

A carbon footprint calculator may also consider air travel. For example, the calculator may multiply the particular individual or entity's air travel by a factor, which represents the average number of miles flown per hour of air travel. The calculator may then use the total climate impact of one air-passenger mile, expressed in (lbs.) of carbon dioxide to determine the final emissions result. Other factors that may be considered include average flight routing efficiency, ground time and average fuel consumption. Alternatively, the calculator may take in the amount of miles flown by the particular individual or entity, or calculate the carbon dioxide emissions attributable to air travel in any other known fashion.

One method that has been used to promote the development of renewable energy is the sale of Renewable Energy Credits (“RECs”). RECs are also known as Green Tags, Renewable Energy Certificates, or Tradable Renewable Certificates (“TRCs”). A REC represents 1,000 kWh (or 1 megawatt-hour) of electricity produced from a renewable energy source. Depending on the location and type of the facility that produces renewable energy and RECs, a REC also represents the avoidance of the emission of 1,000 to 2,000 pounds of carbon dioxide.

Because RECs derive from renewable energy, they serve as a market mechanism that represents the environmental benefits associated with generating power (electricity) from renewable sources. Rather than functioning as a tax on pollution-causing electricity generators, as traditional carbon emissions trading programs do, RECs function as a non-governmental subsidy on pollution-free electricity generators. In states which have a REC program, a REC energy provider (such as a wind farm) is credited with one REC for every 1000 kWh of electricity it produces. A certifying agency gives each REC a unique identification number to make sure it is not double-counted. The REC or green energy is fed into the electrical grid and the accompanying REC can be sold or traded on the open market.

There are two main markets for renewable energy certificates in the United States, compliance markets and voluntary markets. Compliance markets are created by a policy that exists in 25 U.S. states called Renewable Portfolio Standard. In these states, the electric companies are required to supply a certain percent of their electricity from renewable generators by a specified year. By contrast, voluntary markets are ones where customers choose to buy renewable power out of a desire to “go green.” Most corporate and household purchases of renewable energy are voluntary purchases. However, consumers and corporations often do not understand what RECs are, why they should be purchasing them, or how their purchase affects the development of renewable energy.

Voluntary purchasers of RECs may purchase RECs to compensate for their power consumption. In certain embodiments, the carbon footprint estimations described above may be used to estimate how many RECs should be purchased in order to offset carbon use. Preferably, carbon footprint calculators are used to estimate the number of RECs that should be purchased to offset the carbon footprint that has been calculated. Of course, voluntary purchasers of RECs may forego the strict use of a calculator and simply purchase any amount of RECs deemed appropriate.

Product or service providers may also purchase RECs to compensate for the amount of energy consumed in manufacturing processes, rendering services, etc. In this regard, the total amount of energy spent manufacturing products or rendering services may be estimated (e.g., using a calculator, chart or other mechanism) and RECs may be purchased to compensate for the associated carbon footprint. Alternatively, more specific calculations may be used to estimate the carbon footprint of specific product lines, equipment, etc. and RECs purchased accordingly.

Product providers may choose to estimate the amount of energy their products will consume during use. For example, regarding an appliance, a manufacturer, distributor or retailer may wish to purchase an REC for a certain number of appliances to compensate for the expected future carbon footprint of the appliance. By doing so, a business entity can represent to consumers that their products are carbon neutral. Such representations may have considerable marketing value.

Computers or other machines may be used to facilitate the purchase and sale of RECs or other contributions to the renewable energy trust. For instance, a contributor may interact with a computer to make a contribution to the renewable energy trust. Preferably, the computer accesses a website for such purposes. A contributor may also use a computer to interact with a REC vendor and select and purchase RECs. That computer may be equipped with carbon footprint calculator to aid the consumer in the purchase of RECs. A voluntary purchaser may use a computer to navigate to a web page that offers RECs for sale, optionally interacting with an online carbon footprint calculator on that website, selecting an amount of RECs to purchase, and electronically purchasing the RECs. In turn, the contribution is used to fund a renewable energy trust.

Under certain circumstances, it may be advantageous for the contributor to be aware that a certain percentage of the purchase will be used for the development of renewable energy. Preferably, the contributor is aware that 100% of the trust funds will be used for the development of renewable energy. Accordingly, the disclosure provides renewable energy credit purchasers with the satisfaction of knowing that their purchases do not merely enrich the credit sellers. Instead, the purchases fund new renewable energy generation facilities and other worthwhile renewable energy projects.

Similarly, the settlor or vendors of RECs may use computers to interact with contributors or potential contributors to the trust. For example, the trust may be advertised over the internet. Likewise, vendors of RECs can use a computer to market and sell RECs to contributors. This may be accomplished by employing a computer to effectuate the transaction. Alternatively, REC vendors may partner with manufacturers, retailers, utility companies and other entities to have those entities include offers involving the trust, offers for RECs, or other carbon offsets in their course of business. For example, offers for RECs may be incorporated into a utility company's billing system and sent to consumers along with their utility bills. RECs may be also incorporated into a manufacturer, distributor or retailer's computer system so that at the point of purchase customers are given an option to “Make it Green” by purchasing the necessary amount of RECs to compensate for the carbon footprint of the item or service purchased.

In some preferred embodiments, REC vendors may establish internet websites to allow voluntary purchasers to purchase RECs over the internet. These web sites may offer the use of a carbon footprint calculator as described above. Additionally, such web sites may educate potential purchasers regarding RECs and the renewable energy trust. This may be of substantial benefit because many consumers do not understand the nature of RECs, how they are purchased, why they benefit the environment, or how the proceeds may be treated in connection with the trust.

While the use of RECs may be advantageous, it will be appreciated that their purchase is not necessary to experience the benefits of funding new renewable energy projects. Accordingly, the disclosure provides, in part, a novel renewable energy trust as a vehicle to funnel funds into the development of renewable energy technology, projects or facilities whereby the trust is funded in any manner.

A renewable energy trust may be a trust formed in accordance with the laws of a state, with the intention of using the corpus (trust property) for the development of renewable energy.

The settlor for the renewable energy trust may be any person, business or entity. Preferably, the settler is an entity involved in the generation or supply of energy. More preferably, the settlor is a utility company.

In certain embodiments, the settlor may generate, purchase, or otherwise acquire RECs and sell them in any of the manners described above. Alternatively, the settlor may select affiliates who generate, purchase or otherwise acquire RECs and sell or trade them. According to the terms of the renewable energy trust, or the sales of the RECs, all or a percentage of the sales of the RECs may form the corpus of the renewable energy trust. Preferably, a majority of the proceeds of the REC sales are put into the renewable energy trust. More preferably, 100% of the proceeds of the REC sales are contributed into the renewable energy trust.

The trustee of the renewable energy trust may be anyone legally capable of being a trustee under the laws of the state governing the trust.

As noted, an individual, business or other entity may make a direct contribution to the renewable energy trust. In certain embodiments, and for matters of convenience, the contributions may be made directly to the settlor or some other entity associated with the trust and, in turn, placed into the trust. Thus, the present disclosure contemplates any dynamic that transfers contributions, either directly or indirectly, to the renewable energy trust regardless of the means used for doing so. It will also be appreciated that financial contributions may also be made in any manner, including cash, commercial paper, electronic withdrawals, wire transfers, etc.

Contributions to the renewable energy trust need not bear any relationship to a carbon footprint or RECs. However, contributions to the renewable energy trust are preferably made to the trust to offset a carbon footprint. In some cases, RECs are purchased for this purpose. It is also preferable to use a calculator or other mechanism to estimate the carbon footprint which, in turn, is used as a measure of the amount of contribution to the renewable energy trust.

Contributors to the trust may also desire to purchase REC-related products. REC-related products may be anything related to an REC, including without limitation, pens, posters, t-shirts, certificates and other promotional items. In certain embodiments, the REC related products may bear a trademark, logo or insignia affiliated with the renewable energy trust. In certain embodiments, the REC-related products are associated with special offers, certifications, or equipment that generates renewable energy. In certain embodiments, the proceeds of the sales of REC-related products are used, in whole or in part, to fund the renewable energy trust.

The settlor may establish a web site to educate potential contributors about the renewable energy trust, the benefits of renewable energy, how donating to the trust facilitates the development of renewable energy, or how purchasing RECs may further these efforts. Similarly, websites may accept direct contributions or offer the sale of RECs. Such websites may be directed to any of the foregoing methods of facilitating contributions to the trust. For example, calculators may be available on the website which estimate a carbon footprint, an amount of RECs, a monetary amount to offset carbon emissions, a suggested donation amount, or any combination thereof.

Additionally, the settlor, may partner with manufacturers, distributors, retailers, or utility companies to offer consumers the opportunity to contribute directly to the renewable energy trust or purchase RECs such that proceeds will be put into the renewable energy trust. The settlor may also establish a website dedicated to any businesses or other entities that wish to participate in funding the renewable energy trust.

The settlor may partner with manufacturers, service providers, retailers, or distributors to secure purchases of RECs or donations to fund the renewable energy trust based on the production carbon footprint or a product's past or future carbon footprint. In turn, the settlor may authorize participating entities to display a trademark, logo or insignia representing the renewable energy trust on their products, packaging, advertisements or at their place of business.

The settlor may establish criteria for “Green Compliance” with participating businesses or partners. Generally, the Green Compliance may consist of any criteria, but preferably compliance is related to the extent to which the business or partner has furthered “green” initiatives in the form of REC purchases or contributions to the trust. Green Compliance may allow different types of trademarks, logos or insignias to be displayed by the business or partner depending on the type or amount of criteria that has been met. By way of illustration, the criteria may include a certain percentage of the total carbon offset that must be met (e.g., 50% of carbon emissions offset or 100% carbon neutrality) and may be based upon the size of the business (e.g., fixed rates for small, medium and large businesses). Such partners may be given gifts, prizes, plaques, certificates, trademarked pens, educational material, and other materials to encourage the business, partner and/or their employees to continue being “green.”

The settlor may collect information from trust contributors that it may use to provide them with any of the aforementioned benefits. The information collected may be kept in a computer database and include demographic information, volume and frequency of REC purchases, level of contributions to the trust, etc.

The terms of a renewable energy trust will typically dictate the identity of the beneficiary(ies). In general, any individual, business or entity involved in the development of renewable energy technology, products or facilities may be a beneficiary of a renewable energy trust. Other potential beneficiaries include, without limitation, the settlor and/or its affiliates or partners, new and existing renewable energy power plants, utility companies, entities involved in the development of solar, wind, wave, biomass, geothermal, tidal, oceanic, and hydroelectric power, and other forms of renewable energy and the public at large.

In other embodiments, the present disclosure provides a system and method for forming an irrevocable renewable energy trust that receives proceeds from the sale of RECs or REC-related products by the settlor and holds and distributes such proceeds, together with any earnings therefrom, for the settlor's use in the development and construction of renewable generating facilities.

During the continuation of the renewable energy trust, the trustee from time to time distributes funds from the trust for the development of renewable energy. The present disclosure is not limited by the amount trust property, the timing or amount of any given distribution, the type of entity to which the funds are distributed, or the percentages allocated to any entity. The trustee may accumulate any undistributed income and add it to the principal of the trust at least annually.

In certain embodiments, the trustee distributes to or among or for the benefit of the settlor, so much of the income and principal of the trust, as the settlor at any time directs in writing for payment of, or to reimburse the settlor for payment of allowed new renewable generation costs (“ANRGC”).

In certain embodiments, sales proceeds from REC product sales or elsewhere are directed to an irrevocable trust. Such fund flow to the trust is preferably at the discretion of the settlor. Where the settlor has incurred costs associated with the development of renewable energy, the trustee will preferably have instructions to pay these same proceeds to the settlor or the settlor's project affiliate(s) upon receipt of an officer's certificate stating that the costs in the amount of disbursement request have been incurred. The settlor will preferably pay the trust's administrative and certain other costs so as to allow 100% of REC sales or other proceeds to be used for renewable energy projects.

In certain embodiments, the purpose of the irrevocable trust is to receive proceeds from the sale of RECs or REC-related products by affiliates of the settlor and to direct such proceeds towards the development of renewable energy.

In certain embodiments, the trust does not confer upon any purchaser of RECs or REC-related products from the settlor any of the following: any power, right or remedy under or by reason of the trust agreement or pursuant to law, any interest in the trust, any interest in the appointment or distribution of all or any part of the income and principal of the trust for use or application ANRGC, the development of technologies associated with renewable energy generation or related environmental causes or any other purpose, or any interest in any renewable generating facility for which all or any part of the distributed income and principal of the trust may at any time be so used or applied.

Distributions from the trust may be made in the following situations: (1) For payment of or reimbursement for the development of renewable energy and (2) ANRGCs, which are any and all third-party invoices received or paid by the settlor, or any payment obligations that the settlor is contractually obligated to pay, in each case for costs incurred by the settlor in respect of the development of renewable energy that have not yet been placed into commercial service as of the time such costs are incurred, which may consist of any equipment, materials, construction, transmission, land acquisition, easement, lease or other real property-related costs, or land improvement costs. To terminate the trust by distributing the remaining principal and income of the trust (if any). Preferably, when the trust is terminated, the principle and income of the trust are distributed to or for the benefit of the settlor for ANRGC among or for the benefit of the settlor.

The distribution procedure can occur so that disbursements are effected only by a written instrument executed by the settlor and delivered to the trustee. In the case of ANRGC the written instrument may be delivered to the trustee together with: (a) an invoice or proof of payment of an invoice for one or more items of ANRGC or (b) a written agreement, in form reasonably satisfactory to the trustee, in which the settlor attests that such proceeds shall only be used for payment of, or to reimburse the settlor or any of the settlor's affiliates for payment of ANRGC.

The settlor's obligation for trust expenses may include all costs and expenses associated with the administration of the trust and its assets (including, without limitation, taxes, and interest and penalties, and investment management fees, trustee's commissions and other professional fees).

Generally, the trust can continue (a) while renewable energy is being developed; (b) while the settlor is engaged in the development of renewable energy or (c) until the trust is terminated. If: (i) at any time the trustee receives a written certificate from the settlor stating that neither the settlor nor any other party is engaged in the development of renewable energy; or (ii) the trustee receives a final, non-appealable order from a court of competent jurisdiction to the effect that the trust shall terminate because of impossibility of performance, the trust terminates and the trustee distributes all of the principal and income, after necessary expenses. Alternatively, if at any time renewable energy is not being developed, the trust automatically terminates and the trustee distributes all of the principal and income, after necessary expenses.

Ordinarily, the trust may be terminated by distributing the entire principal and income thereof, after necessary expenses, to or among or for the benefit of the settlor, or as the settlor directs.

Unless and until the settlor exercises its authority to terminate the trust, the settlor's authority to direct the distribution of, and the trustee's authority to distribute income and principal of the trust, is preferably limited to the then income and principal of the trust in excess of a predetermined amount.

Typically, in the event the trust is not terminated prior to the expiration of the longest period that property may be held in trust under the law governing the administration of the trust, the trust shall terminate at the end of that period and the then existing principal of such trust, together with any net income then on hand or accrued, is distributed as directed by the settlor, acting at the direction of the disbursement committee.

The flowchart and block diagrams in the FIGS. 1-3 illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may be out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present disclosure has been shown and described in what are considered to be the most practical and preferred embodiments. It is anticipated, however, that departures may be made therefrom and that obvious modifications will be implemented by those skilled in the art.

We claim:

1. A method for funding a renewable energy trust for construction of renewable energy sources coupled to a power grid, comprising:
executing, by a processor, at least one trust management module to facilitate the deposit of funds received from users of energy by directing data over a communications network representing payments to the trust from at least one of renewable energy credits (RECs), REC-related product sales, direct contributions, and donations;
the RECs being provided to consumers of energy connected to the grid, from a power generation system in proportion to the amount of energy respectively consumed from the power generation system, the RECs being represented by data communicated over the communications network to the consumers; and
constructing a portion of a renewable energy source in response to a funding level of the renewable energy trust, a portion of which is funded by the RECs, the renewable energy source coupled to the grid to provide clean energy to consumers of energy.

2. The method of claim 1, wherein the RECs are bundled with a sale of electric power to consumers of energy from the power generation system over the power grid.

3. The method of claim 2, further comprising constructing a portion of a wind farm responsive to determining, by the processor, a funding level of the renewable energy trust.

4. The method of claim 2, further comprising constructing a portion of a solar generation system responsive to determining, by the processor, a funding level of the renewable energy trust.

5. A renewable energy trust management system for funding a renewable energy trust for construction of renewable energy sources coupled to a power grid, comprising:
at least one trust management computer including a processor operably coupled to memory and at least one trust management module stored in the memory and executable by the processor to facilitate the deposit of funds received from users of energy by directing data over a communications network operably coupled to the trust management computer and representing payments to the trust from at least one of renewable energy credits (RECs), REC-related product sales, direct contributions, and donations;
the RECs being provided to consumers of energy connected to the grid, from a power generation system in proportion to the amount of energy respectively consumed from the power generation system, the RECs being represented by data communicated over the communications network to the consumers;
the RECs enabling the construction of a portion of a renewable energy source in response to determining, by the trust management computer, a funding level of the renewable energy trust, a portion of which is funded by the RECs, where the renewable energy source is connected to the grid to provide clean energy to consumers of energy.

6. The trust management system of claim 5, wherein the RECs are bundled with a sale of electric power to consumers of energy from the power generation system over the power grid.

7. The method of claim 6, further comprising constructing a portion of a wind farm responsive to determining, by the processor, a funding level of the renewable energy trust.

8. The method of claim 6, further comprising constructing a portion of a solar generation system responsive to determining, by the processor, a funding level of the renewable energy trust.

9. A computer program product comprising computer usable instructions stored in a non-transitory memory medium for a renewable energy trust management system, the computer usable instructions comprising:
at least one trust management module, executable by a processor of a trust management computer, to facilitate the deposit of funds received from users of energy by directing data over a communications network representing payments to the trust from at least one of renewable energy credits (RECs), REC-related product sales, direct contributions, and donations;
the RECs being provided to consumers of energy connected to the grid, from a power generation system in proportion to the amount of energy respectively consumed from the power generation system, the RECs being represented by data communicated over the communications network to the consumers; and
the trust management module determining a funding level of the renewable energy trust and upon such determination, enabling the construction of a portion of a renewable energy source in response to the determined funding level of the renewable energy trust, a portion of which is funded by the RECs, where the renewable energy source is coupled to the grid to provide clean energy to consumers of energy.

10. The computer program product of claim 9, wherein the RECs are bundled with a sale of electric power to consumers of energy from the power generation system over the power grid.

11. The computer program product of claim 10, further comprising constructing a portion of a wind farm responsive to determining, by the processor, a funding level of the renewable energy trust.

12. The computer program product of claim 10, further comprising constructing a portion of a solar generation system responsive to determining, by the processor, a funding level of the renewable energy trust.

13. The method of claim 1, wherein the RECs provided to a consumer are directly proportional to an amount of electricity purchased for consumption over the power grid.

14. The renewable energy trust management system of claim 5, wherein the RECs provided to a consumer are directly proportional to an amount of electricity purchased for consumption over the power grid.

15. The computer program product of claim 9, wherein the RECs provided to a consumer are directly proportional to an amount of electricity purchased for consumption over the power grid.
